(19) United States
(12) Patent Application Publication
(10) Pub. No.: US 2023/0375459 A1
(43) Pub. Date: Nov. 23, 2023

(54) PARTICLE DETECTION DEVICE, PARTICLE DETECTION SYSTEM, AND PARTICLE DETECTION METHOD

(71) Applicant: Sony Group Corporation, Tokyo (JP)

(72) Inventors: Gakuji Hashimoto, Kanagawa (JP); Mitsunori Ueda, Tokyo (JP); Tsutomu Maruyama, Kanagawa (JP); Isao Hidaka, Tokyo (JP)

(73) Assignee: Sony Group Corporation, Tokyo (JP)

(21) Appl. No.: 18/030,750

(22) PCT Filed: Oct. 15, 2021
(86) PCT No.: PCT/JP2021/038208

§ 371 Date: Apr. 6, 2023

(30) Foreign Application Priority Data
Oct. 15, 2020 (JP) JP2020-174187

(51) Int. Cl. G01N 15/14

(52) U.S. Cl. CPC G01N 15/1459; G01N 15/1463; G01N 2015/149; G01N 2015/1006

(57) ABSTRACT

Provided is a technology for increasing accuracy of a technology which optically detects characteristics of each of particles contained in fluid and analyzes or isolates the detected particles.

Provided is a particle detection device including a light applying unit that applies excitation light to a particle contained in fluid, a light detection unit that detects light emitted by application of the excitation light, and an excitation light detection unit that has an imaging element that detects the excitation light applied to the particle. The light applying unit of the particle detection device according to the present technology may be configured to apply multiple rays of excitation light having different wavelengths from different positions in a flow direction of the fluid. In this case, the excitation light detection unit can detect position information associated with the multiple rays of excitation light.

### TECHNICAL FIELD

The present technology relates to a particle detection device. More specifically, the present technology relates to a particle detection device, a particle detection system, and a particle detection method for optically detecting characteristics of particles.

### BACKGROUND ART

With recent progress in analysis methods, development is gradually proceeding in a field of a method for circulating biological minute particles such as cells and microorganisms, minute particles such as microbeads, or the like in a flow path, and, in a step of circulation, detecting the particles or the like individually and analyzing or isolating the detected particles or the like.

As one typical example of these methods of particle analysis or isolation, technical improvement of an analysis method called flow cytometry is rapidly advancing. Flow cytometry is an analysis method which analyzes or isolates particles by pouring particles corresponding to an analysis target into fluid in a state of alignment of the particles and detecting fluorescence or diffused light emitted from the respective particles by application of laser light or the like to the particles.

For example, in a case of detection of fluorescence from cells, excitation light having an appropriate wavelength and appropriate intensity, such as laser light, is applied to cells labeled with a fluorescence dye. Thereafter, fluorescence emitted from the fluorescence dye is collected by a lens or the like, and light in an appropriate wavelength band is selected with use of a wavelength selective element such as a filter and a dichroic mirror. The selected light is detected with use of a light reception element such as a PMT (photo multiplier tube). At this time, simultaneous detection and analysis of fluorescence are also allowed for multiple fluorescence dyes labeled on cells by combining in plural number the wavelength selective elements and the light reception elements. Moreover, the number of analyzable fluorescence dyes can be increased by multiple rays of excitation light having different wavelengths being combined.

Fluorescence detection of flow cytometry is achievable not only by a method which selects multiple rays of light in discontinuous wavelength bands by using a wavelength selective element such as a filter and measures intensity of rays of light in the respective wavelength bands, but also by a method which measures intensity of rays of light in continuous wavelength bands as a fluorescence spectrum. In spectrum-type flow cytometry capable of measuring a fluorescence spectrum, fluorescence emitted from particles is dispersed using a dispersive element such as a prism and a grating. Thereafter, the dispersed fluorescence is detected using a light reception element array where multiple light reception elements having different detection wavelength bands are arranged. The light reception element array to be used is a PMT array or a photodiode array where light reception elements, such as PMTs and photodiodes, are one-dimensionally arranged, or an array where multiple independent detection channels, such as CCD, CMOS, and other two-dimensional light reception elements, are arranged.

Particle analysis, such as flow cytometry as a typical example, often uses an optical method which applies light, such as laser light, to particles corresponding to an analysis target, and detects fluorescence or diffused light emitted from the particles. Thereafter, analysis is achieved by extracting a histogram with use of an analysis computer and software in reference to detected optical information.

For example, PTL 1 proposes a device which separates biological particles contained in a liquid flow. This device includes an optical mechanism for applying light to each of the biological particles and detecting light from the biological particles, a control unit for detecting a moving speed of each of the biological particles in the liquid flow in reference to light received from each of the biological particles, and a charging unit for charging the biological particles according to the moving speed of each of the biological particles.

### CITATION LIST

### Patent Literature

### [PTL 1]

Japanese Patent Laid-open No. 2009-145213

### SUMMARY

### Technical Problem

A main object is to provide a technology for increasing accuracy of a technology which optically detects characteristics of each of particles contained in fluid and analyzes or isolates the detected particles.

### Solution to Problem

The present technology first provides a particle detection device including a light applying unit that applies excitation light to a particle contained in fluid, a light detection unit that detects light emitted by application of the excitation light, and an excitation light detection unit that has an imaging element that detects the excitation light applied to the particle.

The light applying unit of the particle detection device according to the present technology may be configured to apply multiple rays of excitation light having different wavelengths from different positions in a flow direction of the fluid. In this case, the excitation light detection unit is capable of detecting position information associated with the multiple rays of excitation light.

The particle detection device according to the present technology may further include a processing unit that identifies an interval of the multiple rays of excitation light in reference to the position information detected by the excitation light detection unit.

The particle detection device according to the present technology may further include an oscillation element that applies oscillation to the fluid and an isolation unit that isolates a droplet containing the particle and formed by the oscillation.

In this case, the processing unit is capable of identifying a delay time from excitation light application to the particle to formation of the droplet containing the particle, in reference to the identified interval of the multiple rays of excitation light.

The processing unit of the particle detection device according to the present technology is capable of determining a speed of the particle in reference to the interval of the multiple rays of excitation light and detection timing at which the particle is detected by the light detection unit, and is capable of identifying the delay time in reference to the speed of the particle.

Moreover, the processing unit is capable of identifying the delay time during isolation by using a feature value identified in reference to two or more delay times calculated for two or more different particle speeds.

Specifically, the processing unit is capable of identifying the delay time during isolation by using a feature value identified in reference to a first delay time calculated in a condition of a constant particle speed and a second delay time calculated in a condition where a particle speed difference is produced.

In this case, the second delay time may be a delay time calculated by using light information from particles flowing at two or more different particle speeds in the condition where a particle speed difference is produced.

Further, the processing unit is also capable of identifying the delay time during isolation by using a feature value identified in reference to two or more delay times calculated for two or more different particle speeds in a condition where a particle speed difference is produced.

The particle detection device according to the present technology may include an excitation light calibration unit that calibrates an interval of the excitation light applied to the particle, in reference to the position information associated with the multiple rays of excitation light and acquired by the excitation light detection unit.

The particle detection device according to the present technology may include an abnormality detection unit that detects abnormality of the light applying unit according to excitation light intensity acquired by the excitation light detection unit.

The particle detection device according to the present technology may include a control unit that controls the light applying unit according to excitation light intensity acquired by the excitation light detection unit.

The present technology next provides a particle detection system including a particle detection device that includes a light applying unit that applies excitation light to a particle contained in fluid, a light detection unit that detects light emitted by application of the excitation light, and an excitation light detection unit that has an imaging element that detects the excitation light applied to the particle, and an information processing device that has a processing unit that processes information detected with time by the excitation light detection unit.

The present technology further provides a particle detection method including a light applying step of applying excitation light to a particle contained in fluid, a light detection step of detecting light emitted by application of the excitation light, and an excitation light detection step of detecting, by using an imaging element, the excitation light applied to the particle.

It is assumed that the term “particle” in the present technology includes a wide variety of types of particles, such as a minute particle associated with a living body, including a cell, a microorganism, and a ribosome, and a synthetic particle, including a latex particle, a gel particle, and an industrial particle.

The minute particle associated with a living body includes a chromosome, a ribosome, a mitochondrion, an organelle, and others constituting various types of cells, for example. The cell includes an animal cell (e.g., blood cell) and a plant cell. The microorganism includes a bacterium such as a colon bacillus, a virus such as a tobacco mosaic virus, and a fungus such as a yeast fungus, for example. Moreover, the minute particle associated with a living body may include nucleic acid, protein, and a polymer associated with a living body, such as a composite body of nucleic acid and protein. Further, for example, the industrial particle may be an organic or inorganic polymer material, or metal. The organic polymer material includes polystyrene, styrene divinylbenzene, and polymethyl methacrylate, for example. The inorganic polymer material includes glass, silica, and magnetic material, for example. The metal includes gold colloid and aluminum, for example. Each of these particles typically has a spherical shape in ordinary cases. However, the present technology is also applicable to an aspherical shape. In addition, a size, mass, and the like of each of the particles are not particularly limited to any kind.

### BRIEF DESCRIPTION OF DRAWINGS

FIG. 1 is a schematic conceptual diagram schematically depicting a particle detection device 1 according to a first embodiment of the present technology.

FIG. 2 is a schematic conceptual diagram schematically depicting the particle detection device 1 in an example different from the example of FIG. 1 according to the first embodiment of the present technology.

FIG. 3 is a schematic conceptual diagram schematically depicting a particle detection system 2 according to the first embodiment of the present technology.

FIG. 4 is a schematic conceptual diagram depicting an installation example of an oscillation element 111 and a charging unit 112a.

FIG. 5 is a block diagram of a processing unit 14.

FIG. 6 is a schematic conceptual diagram depicting a device used for identification of a delay time.

FIG. 7 depicts pictures substituted for a drawing and depicting an example of a bright field image and a fluorescence image.

FIG. 8 is a schematic conceptual diagram depicting a delay time calculation method of a Jet in Air detection system.

FIG. 9 is a schematic conceptual diagram depicting an example of a delay time calculation method of a Cuvette detection system.

FIG. 10 is a schematic cross-sectional diagram schematically depicting a cross section inside a Cuvette at the time of calculation of an average flow speed inside the Cuvette with use of Navier-Stokes equations.

FIG. 11 is a flowchart for particle isolation which uses the particle detection device 1 or the particle detection system 2 according to the first embodiment of the present technology.

FIG. 12 is a schematic conceptual diagram schematically depicting the particle detection device 1 according to a second embodiment of the present technology.

FIG. 13 is a schematic conceptual diagram schematically depicting the particle detection device 1 according to a third embodiment of the present technology.

FIG. 14 illustrates schematic conceptual diagrams depicting a liquid sending state used for delay time identification by the particle detection device 1 and the particle detection system 2 according to the third embodiment.

FIG. 15 is a flowchart for delay time adjustment algorithms of the particle detection device 1 and the particle detection system 2 according to the third embodiment.

FIG. 16 is a flowchart for the delay time adjustment algorithms of the particle detection device 1 and the particle detection system 2 according to the third embodiment.

FIG. 17 is a flowchart for the delay time adjustment algorithms of the particle detection device 1 and the particle detection system 2 according to the third embodiment.

FIG. 18 is a flowchart for delay time adjustment algorithms of the particle detection device 1 and the particle detection system 2 according to a modification of the third embodiment.

FIG. 19 is a flowchart for the delay time adjustment algorithms of the particle detection device 1 and the particle detection system 2 according to the modification of the third embodiment.

FIG. 20 is a flowchart for the delay time adjustment algorithms of the particle detection device 1 and the particle detection system 2 according to the modification of the third embodiment.

### DESCRIPTION OF EMBODIMENTS

Preferred modes for carrying out the present technology will hereinafter be described with reference to the drawings. Embodiments described hereinafter are presented as a typical example of embodiments of the present technology. It is not intended that interpretation of the scope of the present technology be narrowed by these embodiments. Note that the description will be given in the following order.
1. Particle detection device 1, particle detection system 2
[First embodiment]
(1) Flow path P
(2) Light applying unit 11
(3) Light detection unit 12
(4) Excitation light detection unit 13
(5) Oscillation element 111
(6) Isolation unit 112
(7) Processing unit 14
(8) Excitation light calibration unit 15
(9) Abnormality detection unit 16
(10) Control unit 17
(11) Storage unit 18
(12) Display unit 19
(13) User interface 110
[Second embodiment]
[Third embodiment]
(1) Processing unit 14
[Modification of third embodiment]
2. Particle detection method

### 1. Particle Detection Device 1, Particle Detection System 2

### First Embodiment

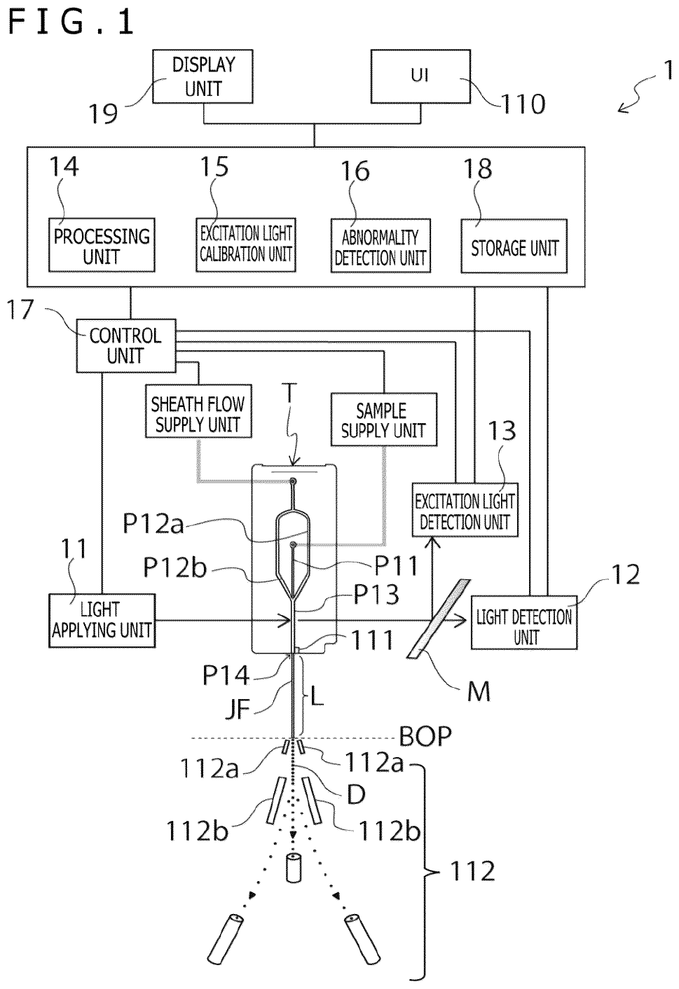

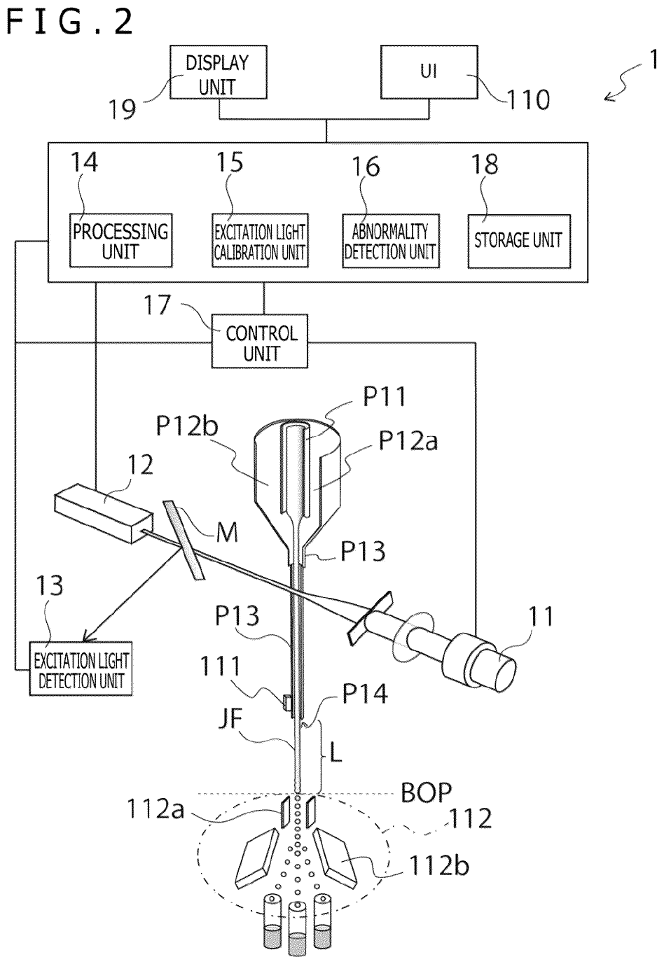

FIG. 1 is a schematic conceptual diagram schematically depicting a particle detection device 1 according to a first embodiment of the present technology. FIG. 2 is a schematic conceptual diagram schematically depicting the particle detection device 1 in an example different from the example of FIG. 1 according to the first embodiment of the present technology. The particle detection device 1 according to the first embodiment includes at least a light applying unit 11, a light detection unit 12, an excitation light detection unit 13, an oscillation element 111, and an isolation unit 112. Moreover, the particle detection device 1 may include flow paths P (P11 to P13), a processing unit 14, an excitation light calibration unit 15, an abnormality detection unit 16, a control unit 17, a storage unit 18, a display unit 19, a user interface 110, and others as necessary.

Note that the processing unit 14, the excitation light calibration unit 15, the abnormality detection unit 16, the control unit 17, the storage unit 18, the display unit 19, the user interface 110, and others may be provided inside the particle detection device 1 as in the particle detection device depicted in FIGS. 1 and 2. However, while not depicted in the figures, there may be provided a particle detection system 2 which includes the particle detection device 1 having the light applying unit 11, the light detection unit 12, the excitation light detection unit 13, the oscillation element 111, and the isolation unit 112, and an information processing device having the processing unit 14, the excitation light calibration unit 15, the abnormality detection unit 16, the control unit 17, the storage unit 18, the display unit 19, and the user interface 110.

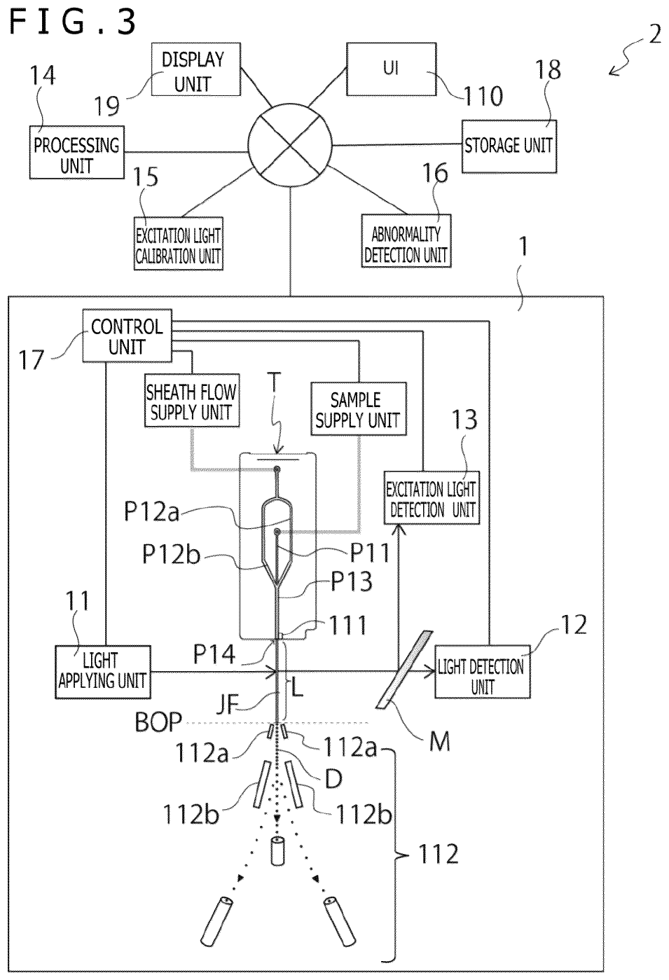

Further, as in the particle detection system 2 according to the first embodiment depicted in FIG. 3, the processing unit 14, the excitation light calibration unit 15, the abnormality detection unit 16, the control unit 17, the storage unit 18, the display unit 19, and the user interface 110 may each be independently provided, and connected to the particle detection device 1 via a network. Note that light detection achieved at a liquid column portion L of a jet flow JF in the particle detection system 2 according to the first embodiment depicted in FIG. 3 is not limited to this manner of detection. For example, light detection may be achieved in the flow paths P as in the examples depicted in FIGS. 1 and 2.

In addition, while not depicted in the figures, the processing unit 14, the excitation light calibration unit 15, the abnormality detection unit 16, the control unit 17, the storage unit 18, and the display unit 19 may be provided in a cloud environment, and connected to the particle detection device 1 via a network. Moreover, while not depicted in the figures, the processing unit 14, the excitation light calibration unit 15, the abnormality detection unit 16, the control unit 17, the display unit 19, and the user interface 110 may be provided inside an information processing device 10, and the storage unit 18 may be provided in a cloud environment and connected to the particle detection device 1 and the information processing device 10 via a network. In this case, it is allowed to store records and the like of various processes performed by the information processing device 10 in the storage unit 18 on the cloud, and share various types of information stored in the storage unit 18 with multiple users. Details of the respective units will be described below.

### (1) Flow Path P

The particle detection device 1 and the particle detection system 2 according to the present technology each achieve particle analysis and isolation by detecting optical information obtained from particles aligned in a line in a flow cell (flow path P).

The flow path P may be provided beforehand in the particle detection device 1 and the particle detection system 2, or may be the flow path P commercially available, or a disposable chip or the like where the flow path P is provided, to achieve analysis or isolation.

In addition, the flow path P is not required to have any specific form, and may have a form freely designed. For example, the flow path P is not limited to the flow path P made of two-dimensional or three-dimensional plastic, glass, or the like and formed inside a substrate T as depicted in FIGS. 1 and 3. The flow path P included in a conventional flow cytometer is also adoptable for the particle detection device 1 as depicted in FIG. 2 referred to below.

Moreover, a flow path width, a flow path depth, and a flow path cross-sectional shape of the flow path P are not particularly limited to any kind and may freely be designed as long as a laminar flow can be generated in the flow path P thus formed. For example, a micro flow path having a flow path width of 1 mm or smaller may be adopted for the particle detection device 1. Particularly, a micro flow path having a flow path width approximately in a range of 10 μm to 1 mm (inclusive) is suited for the present technology.

A method for sending and circulating particles is not particularly limited to any kind. Particles may be circulated within the flow path P according to the form of the flow path P to be used. Described will be a case of the flow path P formed inside the substrate T depicted in FIGS. 1 and 3, for example. Sample liquid which contains particles is introduced into a sample liquid flow path P11, while sheath liquid is introduced into two sheath liquid flow paths P12a and P12b. The sample liquid flow path P11 and the sheath liquid flow paths P12a and P12b join together and constitute a main flow path P13. A sample liquid laminar flow sent within the sample liquid flow path P11 and sheath liquid laminar flows sent within the sheath liquid flow paths P12a and P12b join together within the main flow path P13, and are enabled to constitute a sheath flow where the sample liquid laminar flow is sandwiched between the sheath liquid laminar flows.

Particles to be circulated in the flow path P can be labeled by dyes such as one or two or more types of fluorescence dyes. In this case, examples of the fluorescence dyes available in the present technology include Cascade Blue, Pacific Blue, Fluorescein isothiocyanate (FITC), Phycoerythrin (PE), Propidium iodide (PI), Texas red (TR), Peridinin chlorophyll protein (PerCP), Allophycocyanin (APC), 4′,6-Diamidino-2-phenylindole (DAPI), Cy3, Cy5, Cy7, and Brilliant Violet (BV421).

### (2) Light Applying Unit 11

The light applying unit 11 applies excitation light to particles contained in fluid. The light applying unit 11 may have multiple light sources to apply rays of excitation light having different wavelengths. In this case, the light applying unit 11 may be configured to apply multiple rays of excitation light having different wavelengths from different positions in a flow direction of the fluid.

The type of light to be applied from the light applying unit 11 is not particularly limited to any kind. It is preferable, however, that this light have a fixed light direction, a fixed wavelength, and fixed light intensity to securely achieve emission of fluorescence and diffused light from the particles. For example, a laser, an LED, or others may be used. In a case of use of a laser, the type of the laser is also not limited to a specific type. For example, the laser may be one type of laser selected from an argon ion (Ar) laser, a helium neon (He—Ne) laser, a dye laser, a krypton (Cr) laser, a semiconductor laser, and a solid-state laser combining a semiconductor laser and a wavelength conversion optical element, or two types of lasers selected from these lasers and freely combined.

In addition, excitation light may be applied to particles circulating in the flow path P (main flow path P13) as depicted in the first embodiment in FIGS. 1 and 2 (Cuvette detection system). However, in a case of ejection of fluid from an orifice P14 of the flow path P as the jet flow JF, excitation light may be applied to the liquid column portion L of the jet flow JF as depicted in FIG. 3 (Jet in Air detection system).

The Jet in Air detection system achieves detection in a state where an objective lens is disposed near the liquid column portion L. In this case, liquid easily adheres to the objective lens. In addition, the position of the liquid column portion L shifts every time the orifice P14 is replaced. Accordingly, optical adjustment is needed. Moreover, an air gap is required between the objective lens and the liquid column L. In this case, a high NA lens having NA exceeding 1.0 is not available, and hence, optical detection sensitivity may be lower than those of other methods.

On the other hand, the Cuvette detection system directly attaches the objective lens to a Cuvette portion. Accordingly, droplets D do not adhere to the objective lens. Moreover, optical adjustment is not required even after orifice replacement, for example. Accordingly, the Cuvette detection system is superior to the Jet in Air detection system in view of device maintenance and usability. Furthermore, an air gap is not required between the objective lens and the Cuvette. In this case, a high NA lens having NA exceeding 1.0 is available, and hence, higher optical detection sensitivity than those of other methods is acquirable.

### (3) Light Detection Unit 12

The light detection unit 12 detects light emitted by application of the excitation light. Specifically, the light detection unit 12 detects fluorescence or diffused light emitted from particles, and converts the detected fluorescence or diffused light into electric signals.

According to the present technology, a specific light detection method of a light detector available as the light detection unit 12 is not particularly limited to any kind as long as light signals from particles are detectable. Light detection methods used by known light detectors may freely be selected and adopted. For example, one type of light detection method selected from light detection methods used by various types of spectrum measuring devices, such as a fluorescence measuring device, a diffused light measuring device, a transmitted light measuring device, a reflection light measuring device, a diffraction light measuring device, an ultraviolet spectroscopy measuring device, an infrared spectroscopy measuring device, a Raman spectroscopy measuring device, a FRET measuring device, and a FISH measuring device; a PMT array or a photodiode array where light reception elements such as PMTs and photodiodes are one-dimensionally arranged; and a unit where multiple independent detection channels, such as CCD, CMOS, and other two-dimensional light reception elements, are arranged may be adopted, or two or more types selected from these light detection methods may freely be combined and adopted.

### (4) Excitation Light Detection Unit 13

The excitation light detection unit 13 is characterized by including an imaging element. The imaging element captures an image of a state of excitation light applied to particles. An actual position of the excitation light on a focal plane of the objective lens changes with time by an effect of heat generated from the light applying unit 11 and the particle detection device 1 themselves. According to the present technology, an image of a state of the excitation light applied to particles can be captured and detected by the imaging element included in the excitation light detection unit 13. Accordingly, changes of the excitation light with time are recognizable, and recognition of these changes contributes to improvement of detection accuracy.

Note that the image of the excitation light may be captured by an imaging device such as a CCD camera and a CMOS camera, or by various types of imaging elements such as a photoelectric conversion element. Moreover, while not depicted in the figures, a shift mechanism for changing a position of the imaging element may be provided on the imaging element. Further, while not depicted in the figures, a light source for illuminating an imaging area may be provided in the particle detection device 1 of the present embodiment in conjunction with the imaging element.

In addition, in a case where fluorescence is detected by the light detection unit 12, total reflection of the excitation light toward the excitation light detection unit 13 may be caused with use of a dichroic mirror M or the like, for example. Alternatively, this reflection is achievable by total reflection toward the light detection unit 12 facing the light applying unit 11, by using a mirror having a fixed ratio, such as a half mirror, or a range not affecting diffused light or the like detected by the light detection unit 12 (e.g., the same NA as that for excitation light). Instead, while not depicted in the figures, the excitation light detection unit 13 may be implemented by capturing an image of the excitation light with use of a low-reflection mirror provided before the objective lens.

In a case where the light applying unit 11 is so configured as to apply multiple rays of excitation light having different wavelengths from different positions in the flow direction of the fluid, position information associated with the rays of excitation light is detectable by the excitation light detection unit 13.

Moreover, the excitation light detection unit 13 is capable of detecting intensity of the excitation light. Specifically, the excitation light detection unit 13 is capable of detecting an intensity distribution of the excitation light, such as a short axis intensity distribution and a long axis intensity distribution, in real time. Further, the excitation light detection unit 13 is also capable of detecting a shape of the excitation light, such as a width, a length, and an inclination, in real time. In addition, the excitation light detection unit 13 is capable of detecting a relative position and an absolute position of the excitation light in real time.

The particle detection device 1 according to the present technology is capable of recognizing a condition of the device by recording changes with time, such as changes per hour and changes per day, produced in the above-described excitation information detected by the excitation light detection unit 13.

Moreover, in a case where intensity of the excitation light differs for each excitation wavelength, or sensitivity of the imaging element differs for each excitation wavelength, the image of the excitation light is captured multiple times while switching to a camera gain suited for each ray of the excitation light is performed. In this manner, an accurate excitation light state is recognizable. In this case, however, correct detection becomes difficult when the image is subjected to over exposure or under exposure. Accordingly, some measures, such as imaging multiple times with a camera gain suited for each ray of the excitation light, need to be taken.

Abnormality of the device is detectable by the excitation light detection unit 13 having the foregoing functions being provided. Moreover, an abnormal condition is recognizable in real time. Accordingly, readjustment of the excitation light is achievable automatically or by remote operation.

Further, light signal intensity detected by the light detection unit 12 is dependent on excitation light intensity, and hence, is manageable as quantitative light signal intensity by detection of intensity of the excitation light.

In addition, light signals detected by the light detection unit 12 are correctable according to intensity changes of the excitation light. As a result, light detection accuracy can improve.

### (5) Oscillation Element 111

According to the particle detection device 1 of the present technology, the oscillation element 111 forms droplets containing the particles. Specifically, at the time of ejection of fluid containing particles as the jet flow JF from the orifice P14 of the flow path P13, a horizontal cross section of the jet flow JF is modulated in the vertical direction in synchronization with a frequency of the oscillation element 111 by the whole or a part of the main flow path P13 being oscillated with use of the oscillation element 111 oscillating at a predetermined frequency. As a result, the droplets D are separated and produced at a breakoff point BP.

Note that the oscillation element 111 used in the present technology is not limited to a specific element. Any type of oscillation element 111 available for a general flow cytometer may freely be selected and used. For example, a piezoelectric oscillation element may be used. Moreover, the droplets D each containing a fixed quantity of particles and having an adjusted size can be produced by adjustment of liquid sending quantities for the sample liquid flow path P11, the sheath liquid flow paths P12a and P12b, and the main flow path P13, a diameter of a discharge port, a frequency of oscillation of the oscillation element, and the like.

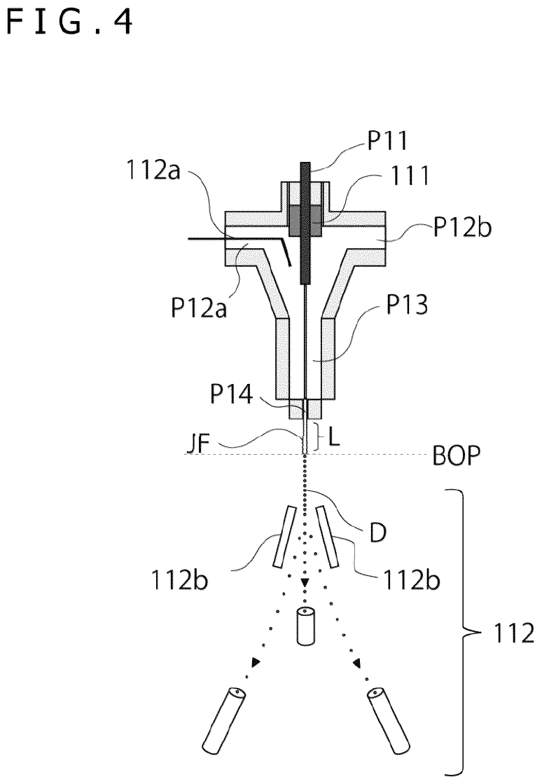

According to the present technology, the oscillation element 111 is not required to be disposed at a specific position, and may freely be arranged as long as droplets containing the particles can be formed. For example, the oscillation element 111 may be disposed in the vicinity of the orifice P14 of the flow path P13 as depicted in FIGS. 1 to 3, or may be disposed in an upstream region of the flow path P to oscillate a sheath flow in the whole or a part of the flow path P or inside the flow path P as depicted in FIG. 4.

### (6) Isolation Unit 112

The isolation unit 112 isolates the droplets D containing the particles and produced by the oscillation element 111. Specifically, the droplets D are positively or negatively charged according to an analysis result of a particle size, a form, an internal structure, or the like analyzed from light signals detected by the light detection unit 12 (see reference number 112a). Subsequently, after changing a traveling direction of the charged droplets D to a desired direction by counter electrodes 112b to which voltage is applied, the droplets D are isolated.

According to the present technology, the charging unit 112a is not required to be disposed at a specific position, and may freely be arranged as long as the droplets D containing the particles can be charged. For example, the droplets D may be directly charged on the downstream side of the breakoff point BOP as depicted in FIGS. 1 to 3, or may be charged via sheath liquid immediately before formation of the droplets D containing target particles by the charging unit 112a including an electrode or the like being arranged in the sheath liquid flow path P12a or P12b or other positions as depicted in FIG. 4.

### (7) Processing Unit 14

The particle detection device 1 according to the present technology may include the processing unit 14 which identifies an interval of the multiple rays of excitation light in reference to position information detected by the excitation light detection unit. Note that the processing unit 14 is not an indispensable component in the first embodiment. However, if the processing unit 14 for identifying intervals of the multiple rays of excitation light is provided, accuracy of light detection performed by the light detection unit 12 can improve.

Moreover, the processing unit 14 is capable of identifying an interval of the multiple rays of excitation light in reference to the position information detected by the excitation light detection unit 13, and identifying a delay time from application of the rays of excitation light to the particles to formation of droplets containing the particles, in reference to the identified interval of the multiple rays of excitation light.

For example, PTL 1 described above obtains a moving speed of particles in reference to an excitation light spot interval, and controls charging timing for droplets D containing the particles, in reference to the obtained moving speed. However, changes of the excitation light spot interval with time are not taken into consideration in the method of PTL 1. Excitation light is affected by heat generated from the light applying unit 11 or the particle detection device 1 itself. In this case, an actual position of the excitation light on a focal plane of the objective lens changes with time by the effect of the heat generated from the light applying unit 11 and the particle detection device 1 themselves. Accordingly, if the excitation light spot interval changes with time after sorting adjustment, optimum charging timing is difficult to calculate by the conventional technology.

Particularly, in a case of a cell sorter having a high-speed sorting processing ability, the liquid column portion L of the jet flow JF tends to increase by high-pressure liquid sending. Accordingly, a ratio of a distance defined between an excitation light position and the breakoff point BP where the droplets are formed to the excitation light spot interval increases. In this case, a change of the excitation light spot interval considerably affects identification of the delay time.

Moreover, the cell sorter having the high-speed sorting processing ability has a high driving frequency of the oscillation element 111 which forms droplets. In proportion to the high driving frequency, accuracy required for an arrival time at the droplet charging position increases. Accordingly, a change of the excitation light spot interval considerably affects identification of the delay time.

In addition, in a case of isolation of particles by the Jet in Air detection system (see FIG. 10), excitation light application, light detection, and droplet charging are carried out while detection target particles are passing through the liquid column portion. In this case, a waiting time from excitation light application to charging is relatively short. Accordingly, adjustment accuracy of the delay time is high. Further, a speed distribution inside the liquid column is constant at any position of each particle. Accordingly, an increase in a sample core diameter does not considerably affect identification of the delay time. On the other hand, in a case of isolation of particles by the Cuvette detection system, detection is carried out by the Cuvette portion, and fluid is ejected from the orifice P14 of the flow path P as the jet flow JF. Thereafter, droplets are charged at the liquid column portion L. Accordingly, a waiting time until charging is long, and the delay time is easily affected by the liquid sending speed. Moreover, if the liquid sending speed changes after sorting adjustment, sorting performance considerably deteriorates.

According to the present technology, hence, the excitation light detection unit 13 detects actual positions of rays of excitation light, and the processing unit 14 identifies an interval of the multiple rays of excitation light in reference to information associated with the actual positions of the rays of excitation light, and identifies a delay time from application of the rays of excitation light to the particles to formation of droplets containing the particles, in reference to the identified interval of the multiple rays of excitation light. Accordingly, even in a case of changes of the actual positions of the rays of excitation light with time, adjustment accuracy of the delay time can improve.

Moreover, the processing unit 14 can determine the speed of the particles in reference to the interval of the multiple rays of excitation light and detection timing of the particles by the light detection unit 12, and identify the delay time in reference to the speed of the particles. Accordingly, even in a case of changes of the liquid sending speed after sorting adjustment, adjustment accuracy of the delay time can improve.

A specific method for identifying a delay time will hereinafter be described.

### <General Configuration of Processing Unit 14>

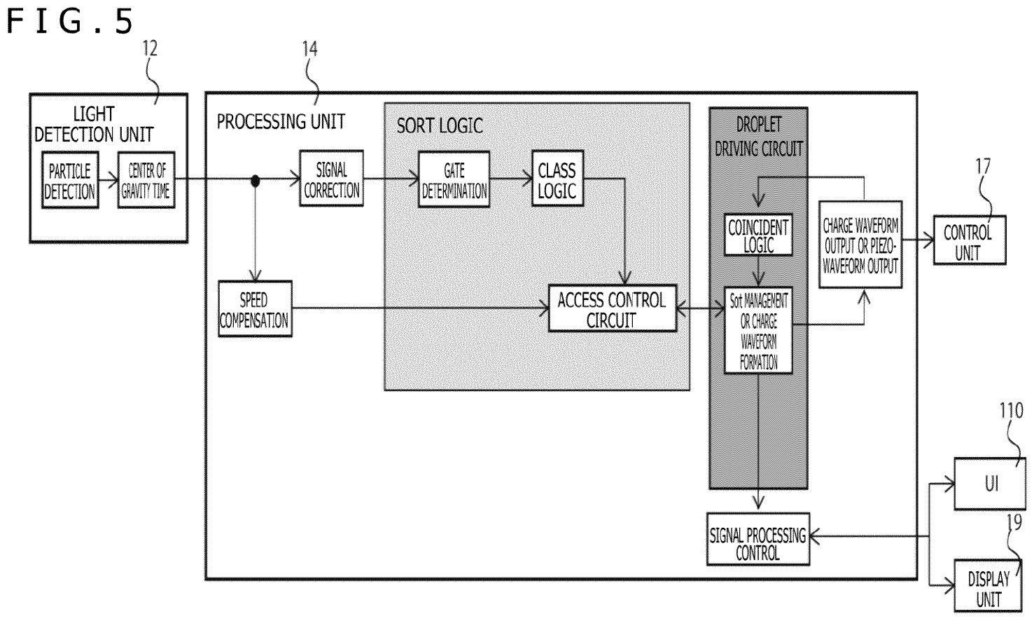

FIG. 5 is a block diagram of the processing unit 14. The light detection unit 12 detects light emitted from a particle by application of excitation light from the light applying unit 11. The detected light is sent to the processing unit 14. A signal detected by the processing unit 14 is corrected as necessary, and necessity or unnecessity of isolation of the particle is determined by gate determination and a class logic of a sort logic unit and a coincident logic of a droplet driving circuit unit. Thereafter, a charging quantity of the isolation unit 112 is set by a charge waveform generation unit.

In parallel with the above, a time of a center of gravity is calculated from a pulse signal waveform of the particle detected by the light detection unit 12, and a delay time is identified by the processing unit 14 with use of the following method. An access control circuit is updated in reference to this information, charging timing is determined, and a charging waveform is generated by the droplet driving circuit unit.

### <Devices to be Used and Procedures>

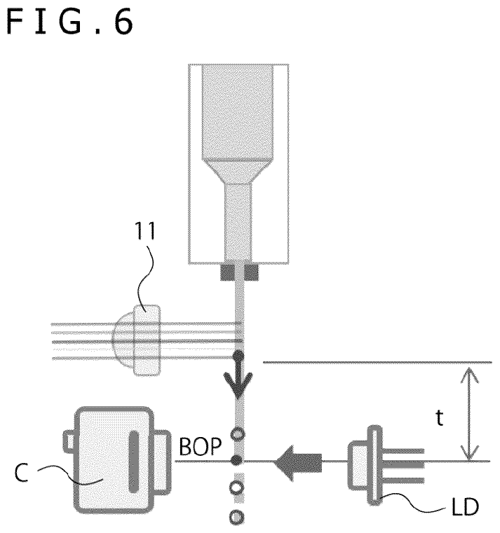

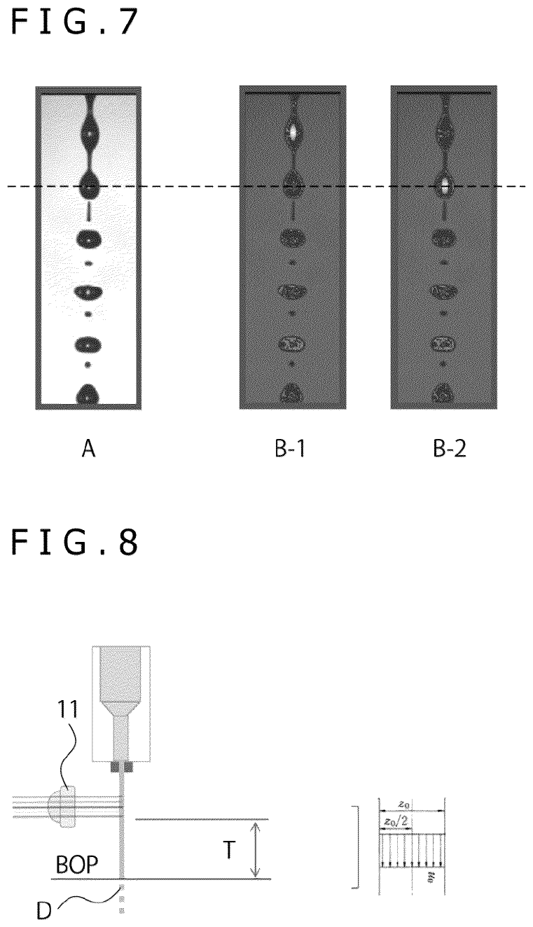

For adjustment of a delay time, a strobe light emission device LD, a camera C, and adjustment beads depicted in FIG. 6 as well as a bright field image and a fluorescence image are used. According to bright field observation which causes strobe light emission in synchronization with the oscillation element 111 for oscillating the droplets D, observation of the droplets D is achievable as an image of a stationary state (see FIG. 7A). On the other hand, according to fluorescence image observation which causes strobe light emission of excitation light at a fixed time after detection of particles, a position check of adjustment beads detected during strobe light emission is achievable (see FIGS. 7 B1 and 7B2). An appropriate delay time T can be obtained with use of the foregoing droplet images and performance of the following adjustment procedures.

(a) Any core diameter (e.g., approximately 5 μm) is set to create a state where no particle speed difference is produced.

(b) The droplet observation camera C is set to a bright field mode to produce a state where an image of a charging point for charging the droplets D (breakoff point BOP) can be captured.

(c) Voltage of the oscillation element 111 for forming droplets is adjusted to align a center of a droplet at a farthest end of the liquid column portion L with an image reference position (see broken line in FIG. 7) (see FIG. 7A).

(d) The droplet observation camera is switched to a mode of a fluorescence image. A light emission time: t of strobe lighting from particle detection is gradually increased from 0 while fluorescence beads for adjustment are fed (see FIG. 7B-1).

(e) A strobe light emission time: t at which a center of gravity of a light emission point agrees with the image reference position is adopted as a delay time (see FIG. 7B-1).

### <Calculation of Delay Time by Jet in Air Detection System>

A delay time can be calculated using the equation (1) presented below by the Jet in Air detection system (see FIG. 8).

[Math. 1]

Delay Time=x/v (1)
distance between light detection and breakoff point BOP: x
particle speed at liquid column portion: v

### <Calculation of Delay Time by Cuvette Detection System>

A delay time can be calculated using the equation (2) presented below by the Cuvette detection system.

$$\begin{matrix}[ Math . 2 ] & \\ \begin{matrix}Delay Time ( t 2 + t 3 ) = x 2 / v 2 + x 3 / v 3 \\ = x 2 / x 1 \times t 1 + x 3 / v 3\end{matrix} & ( 2 )\end{matrix}$$

laser spot passing time: t1
laser spot interval: x1
particle speed during laser spot passing: v1
Cuvette passing time: t2
Cuvette passing distance: x2
Cuvette particle speed: v2 (v1=v2)
liquid column portion passing time: t3
liquid column portion passing distance: x3
liquid column portion particle speed: v3

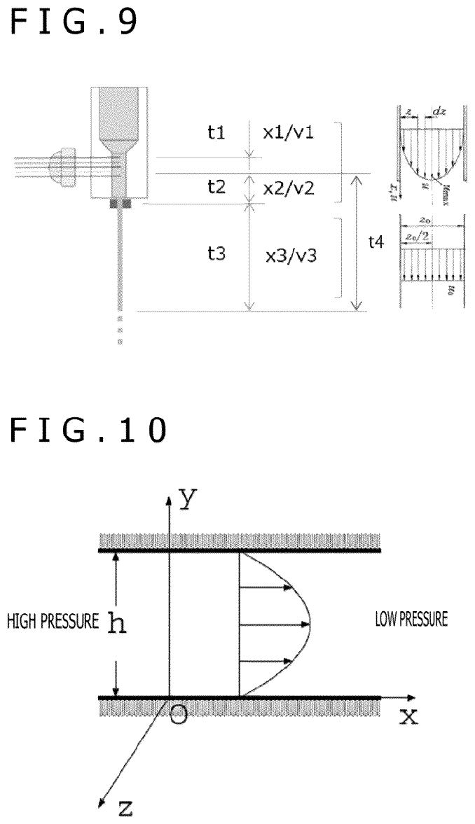

A speed distribution inside the liquid column is constant at any position of each particle. On the other hand, a speed distribution of Hagen-Poiseuille depicted in FIG. 9 is exhibited in a micro flow path inside the Cuvette. In this case, the particle speed varies as the sample core diameter increases. Accordingly, a delay time suited for each individual speed needs to be accumulated.

An average flow speed inside the Cuvette can be calculated by the following equation (3) under Navier-Stokes equations (see FIG. 10).

$$\begin{matrix}[ Math . 3 ] & \\ Q = {\int }_{0}^{r 0} 2 π rudr = - \frac{1}{8 μ} π {r}_{0}^{4} ( \frac{dp}{dx} ) & ( 3 )\end{matrix}$$

$${U}_{mean} = \frac{Q}{π {r}_{0}^{2}} = - \frac{1}{8 μ} ( \frac{dp}{dx} ) {r}_{0}^{2} = \frac{{U}_{max}}{2}$$

center flow speed: Umax
flow quantity: Q
average flow speed: Umean

Specifically, the average flow speed: v2mean can be obtained by calculation of the particle speed: v2 (corresponding to Umax) inside the Cuvette. A flow speed of liquid is inversely proportional to a flow path cross section. Accordingly, a particle speed at the liquid column portion can be calculated by the following equation (4).

[Math. 4]

v3=(flow path cross-sectional area)/(orifice area)×v1 (4)

Meanwhile, assuming that a flow path cross-sectional area inside the Cuvette is a2 and that a flow path cross-sectional area at the liquid column portion is a3 in the equation (2) presented above, a liquid quantity discharged as a liquid column is equivalent to a flow quantity inside the Cuvette, and is hence proportional to the cross-sectional area. Accordingly, the liquid column portion particle speed v3 is represented as the following equation (5) by the Cuvette particle speed: v2.

[Math. 5]

v3=½×v2×a2/a3 (5)
average flow speed inside Cuvette: ½×v2

By substituting the equation (5) for the equation (2) presented above, the delay time can be calculated by the following equation (6).

$$\begin{matrix}[ Math . 6 ] & \\ \begin{matrix}Delay Time = x 2 / v 2 + x 3 / v 3 \\ = x 2 / x 1 \times t 1 + x 3 / ( 1 / 2 \times x 1 / t 1 \times a 2 / a 3 ) \\ = ( x 2 + 2 \times x 3 \times a 3 / a 2 ) / x 1 \times t 1\end{matrix} & ( 6 )\end{matrix}$$

laser spot passing time: t1
laser spot interval: x1
particle speed during laser spot passing: v1
Cuvette passing time: t2
Cuvette passing distance: x2
Cuvette particle speed: v2 (v1=v2)
liquid column portion passing time: t3
liquid column portion passing distance: x3
liquid column portion particle speed: v3=½×v2×a2/a3
flow path cross-sectional area inside Cuvette: a2
flow path cross-sectional area at liquid column portion: a3

As apparent from the equation (6) presented above, assuming that each of the flow path cross-sectional areas: a2 and a3 is a constant, the delay time is a value calculated by multiplying (x2+b×x3)/x1 by the laser passing time: t1. The laser spot interval: x1 is a value approximately 1 mm or smaller by a limitation imposed by a lens visual field, while the distance between optical detection and the breakoff point BOP is a value of approximately several tens mm. Accordingly, even in a case where only a small change is produced in the excitation light spot interval, identification of the delay time is considerably affected by this change as an error of several score times larger. In these circumstances, speed compensation achieved by the conventional system requires extremely high stability (Pointing Stability) of the excitation light, and hence, sufficient stability of a sorting system has been difficult to ensure.

As such, according to the present technology, the excitation light detection unit 13 is provided to highly accurately measure an initial value of an excitation light spot interval and a change of the interval with time. Accordingly, highly accurate delay time management is realized by construction of a system which reflects the measured initial value of the excitation light spot interval and the change of the interval with time in delay time calculation. In such a manner, robustness of delay time management corresponding to each particle speed improves, and hence, stable sorting performance is realizable.

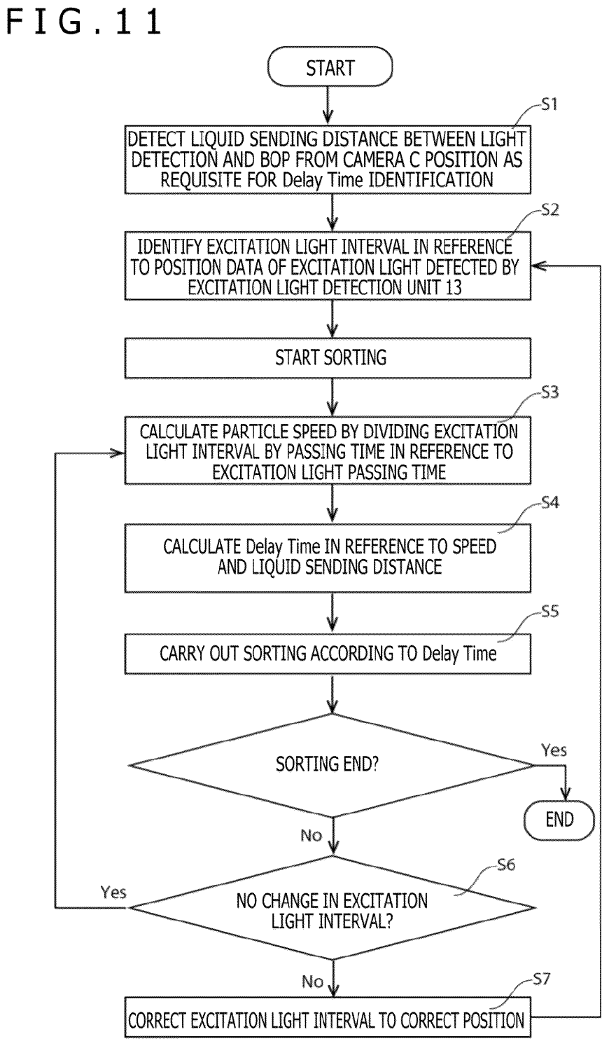

FIG. 11 illustrates a specific flowchart for particle isolation. First, a liquid sending distance between light detection and the breakoff point BOP, as a distance necessary for identification of a delay time, is detected from a position of the camera C (S1). Subsequently, the processing unit 14 identifies an interval of rays of excitation light in reference to position information associated with the rays of excitation light detected by the excitation light detection unit 13 (S2), and starts sorting. A particle speed is calculated by dividing the excitation light interval by a passing period with use of a time when a particle has passed through the excitation light (S3), and a delay time is calculated by the particle speed and a liquid sending distance (S4). Sorting is carried out according to the calculated delay time (S5). In a case of continuing sorting, in reference to position information associated with the excitation light detected by the excitation light detection unit 13, S3 to S6 are repeated in a case of absence of a change of the excitation light interval, or S2 to S6 are repeated after correction of the excitation light interval to a correct position (S7) in a case of presence of a change of the excitation light interval.

### (8) Excitation Light Calibration Unit 15

The particle detection device 1 according to the present technology may include the excitation light calibration unit 15 which calibrates an interval of the multiple rays of excitation light applied to the particles, in reference to position information associated with the multiple rays of excitation light and acquired by the excitation light detection unit 13. Note that the excitation light calibration unit 15 here is not an indispensable component in the first embodiment. However, if the excitation light calibration unit 15 for calibrating the interval of the rays of excitation light to be applied to the particles is provided, accuracy of light detection performed by the light detection unit 12 can improve. Moreover, if the excitation light calibration unit 15 for calibrating the interval of the rays of excitation light to be applied to the particles is provided in a second embodiment and a fourth embodiment described below, accuracy of particle isolation performed by the isolation unit 112 described below can improve in addition to the improvement of accuracy of light detection performed by the light detection unit 12.

### (9) Abnormality Detection Unit 16

The particle detection device 1 according to the present technology may include the abnormality detection unit 16 which detects abnormality of the light applying unit 11 in reference to intensity of excitation light acquired by the excitation light detection unit 13. Note that the abnormality detection unit 16 here is not an indispensable component in the first embodiment. However, if the abnormality detection unit 16 for detecting abnormality of the light applying unit 11 is provided, optical adjustment of the light applying unit 11 can be performed in reference to information obtained by the excitation optical detection unit 13 in a case of detection of abnormality of the light applying unit 11 by the abnormality detection unit 16, for example. As a result, accuracy of particle detection can improve. Moreover, in a case where an abnormal condition is not avoidable even by optical adjustment of the light applying unit 11 in reference to information obtained by the excitation optical detection unit 13, such measures as a stop of particle isolation by the isolation unit 112 are allowed to be taken. In this manner, execution of useless isolation work is avoidable.

### (10) Control Unit 17

The particle detection device 1 according to the present technology may include the control unit 17 which controls the light applying unit 11 in reference to excitation light intensity acquired by the excitation light detection unit 13. Specifically, the control unit 17 is capable of achieving optical adjustment of the light applying unit 11 in reference to information acquired by the excitation optical detection unit 13. Moreover, the control unit 17 is also capable of correcting light signal intensity from particles detected by the light detection unit 12, in reference to an excitation light intensity change acquired by the excitation light detection unit 13.

Note that the control unit 17 here is not an indispensable component in the first embodiment. However, if the control unit 17 for controlling the light applying unit 11 is provided, it is avoidable to cause such a situation where optical information detected by the light detection unit 12 is affected by an intensity change of the light applying unit 11. As a result, detection accuracy and isolation accuracy can improve.

### (11) Storage Unit 18

The particle detection device 1 and the particle detection system 2 according to the present technology may each include the storage unit 18 for storing various types of data. For example, the storage unit 18 is capable of storing any types of data associated with particle detection and particle isolation, such as light signal data from particles detected by the light detection unit 12, excitation light data detected by the excitation light detection unit 13, processing data processed by the processing unit 14, excitation light calibration data calibrated by the excitation light calibration unit 15, abnormality data detected by the abnormality detection unit 16, control data controlled by the control unit 17, and isolation data of particles isolated by the isolation unit 112 described below.

Moreover, the storage unit 18 in the present technology is allowed to be provided in a cloud environment as described above. Accordingly, various types of information recorded in the storage unit 18 on a cloud can also be shared by respective users via a network.

Note that the storage unit 18 is not an indispensable component in the present technology. Various types of data may be stored using an external storage device or the like.

### (12) Display Unit 19

The particle detection device 1 and the particle detection system 2 according to the present technology may each include the display unit 19 for displaying various types of data. For example, the display unit 19 is capable of displaying any types of data associated with particle detection and particle isolation, such as light signal data from particles detected by the light detection unit 12, excitation light data detected by the excitation light detection unit 13, processing data processed by the processing unit 14, excitation light calibration data calibrated by the excitation light calibration unit 15, abnormality data detected by the abnormality detection unit 16, control data controlled by the control unit 17, and isolation data of particles isolated by the isolation unit 112 described below.

Note that the display unit 19 is not an indispensable component in the present technology. An external display device may be connected. For example, the display unit 19 may include a display, a printer, or the like.

### (13) User Interface 110

The particle detection device 1 and the particle detection system 2 according to the present technology may each include the user interface 110 which is a part to be operated by a user. The user is capable of accessing respective units and respective devices via the user interface 110 to control the respective units and the respective devices.

The user interface 110 is not an indispensable component in the present technology. An external operation device may be connected. For example, the user interface 110 may include a mouse, a keyboard, or the like.

### Second Embodiment

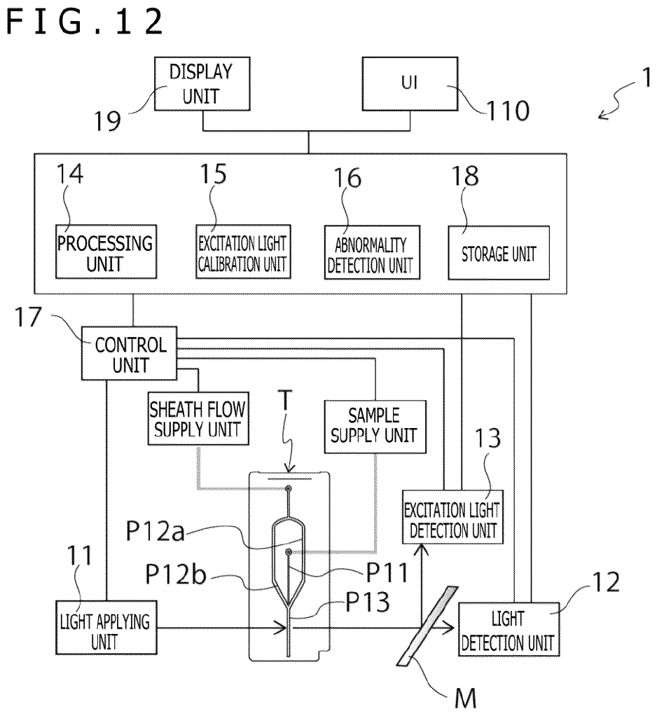

FIG. 12 is a schematic conceptual diagram schematically depicting the particle detection device 1 according to the second embodiment of the present technology. The particle detection device 1 according to the second embodiment includes at least the light applying unit 11, the light detection unit 12, and the excitation light detection unit 13. Accordingly, the oscillation element 111 and the isolation unit 112 are not indispensable components for the particle detection device 1 of the second embodiment. Moreover, the particle detection device 1 may include the flow paths P (P11 to P13), the processing unit 14, the excitation light calibration unit 15, the abnormality detection unit 16, the control unit 17, the storage unit 18, the display unit 19, the user interface 110, and others as necessary.

Note that the processing unit 14, the excitation light calibration unit 15, the abnormality detection unit 16, the control unit 17, the storage unit 18, the display unit 19, the user interface 110, and others may be provided inside the particle detection device 1 as in a manner depicted in the particle detection device 1 in FIG. 12. However, while not depicted in the figures, there may be provided the particle detection system 2 which includes the particle detection device 1 having the light applying unit 11, the light detection unit 12, and the excitation light detection unit 13 and the information processing device 10 having the processing unit 14, the excitation light calibration unit 15, the abnormality detection unit 16, the control unit 17, the storage unit 18, the display unit 19, and the user interface 110.

Further, while not depicted in the figures, the processing unit 14, the excitation light calibration unit 15, the abnormality detection unit 16, the control unit 17, the storage unit 18, the display unit 19, and the user interface 110 may be independently provided, and connected to the particle detection device 1 via a network.

In addition, while not depicted in the figures, the processing unit 14, the excitation light calibration unit 15, the abnormality detection unit 16, the control unit 17, the storage unit 18, and the display unit 19 may be provided in a cloud environment, and connected to the particle detection device 1 via a network. Further, while not depicted in the figures, the processing unit 14, the excitation light calibration unit 15, the abnormality detection unit 16, the control unit 17, the display unit 19, and the user interface 110 may be provided inside the information processing device 10, and the storage unit 18 may be provided in a cloud environment and connected to the particle detection device 1 and the information processing device 10 via a network. In this case, it is allowed to store records and the like of various processes performed by the information processing device 10 in the storage unit 18 on the cloud, and share various types of information stored in the storage unit 18 with multiple users.

Note that respective parts of the particle detection device 1 and the particle detection system 2 according to the present technology are similar to corresponding parts described in the first embodiment. Accordingly, description of those parts is omitted here.

### Third Embodiment

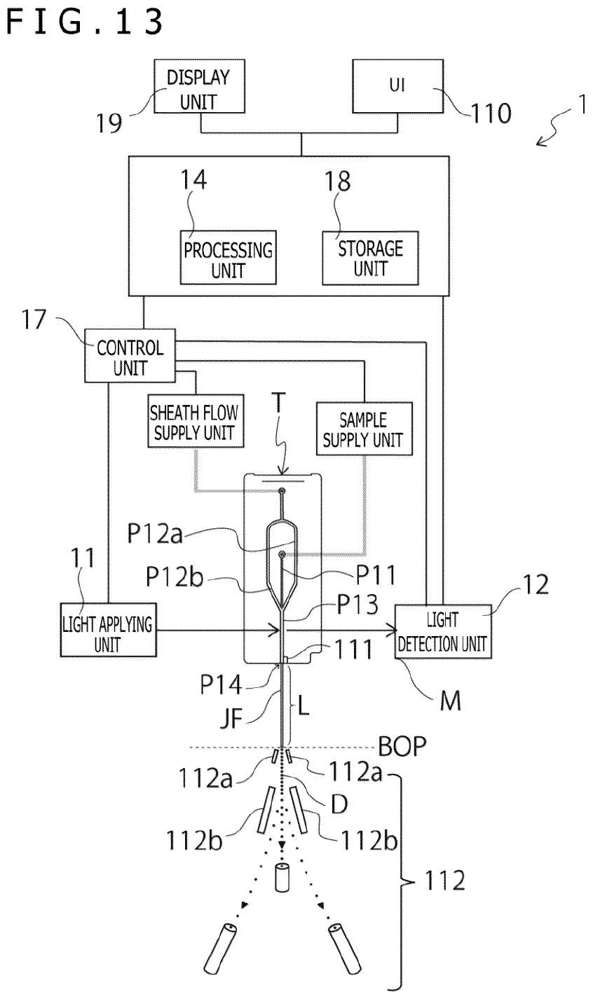

FIG. 13 is a schematic conceptual diagram schematically depicting the particle detection device 1 according to a third embodiment of the present technology. The particle detection device 1 according to the third embodiment includes at least the light applying unit 11, the light detection unit 12, the oscillation element 111, the isolation unit 112, and the processing unit 14. Accordingly, the excitation light detection unit 13 is not an indispensable component for the particle detection device 1 of the third embodiment. However, needless to say, the particle detection device 1 may also include the flow paths P (P11 to P13), the excitation light detection unit 13, the excitation light calibration unit 15, the abnormality detection unit 16, the control unit 17, the storage unit 18, the display unit 19, the user interface 110, and others as necessary.

Note that the processing unit 14, the excitation light calibration unit 15, the abnormality detection unit 16, the control unit 17, the storage unit 18, the display unit 19, the user interface 110, and others may also be provided inside the particle detection device 1 in the third embodiment as in the manner of the particle detection device 1 of the first embodiment depicted in FIGS. 1 and 2. However, as in the first embodiment described above, there may be provided the particle detection system 2 which includes the particle detection device 1 having the light applying unit 11, the light detection unit 12, the excitation light detection unit 13, the oscillation element 111, and the isolation unit 112 and the information processing device 10 having the processing unit 14, the excitation light calibration unit 15, the abnormality detection unit 16, the control unit 17, the storage unit 18, the display unit 19, and the user interface 110.

Further, as in the first embodiment described above, it is also allowed in the third embodiment to provide the processing unit 14, the excitation light calibration unit 15, the abnormality detection unit 16, the control unit 17, the storage unit 18, the display unit 19, and the user interface 110 independently of each other, and connect these components to the particle detection device 1 via a network.

In addition, as in the first embodiment, it is also allowed in the third embodiment to provide the processing unit 14, the excitation light calibration unit 15, the abnormality detection unit 16, the control unit 17, the storage unit 18, and the display unit 19 in a cloud environment, and connect these components to the particle detection device 1 via a network. Further, as in the first embodiment described above, it is also allowed to provide the processing unit 14, the excitation light calibration unit 15, the abnormality detection unit 16, the control unit 17, the display unit 19, and the user interface 110 within the information processing device 10, and also provide the storage unit 18 in a cloud environment and connect the storage unit 18 to the particle detection device 1 and the information processing device 10 via a network. In this case, it is allowed to store records and the like of various processes performed by the information processing device 10 in the storage unit 18 on the cloud, and share various types of information stored in the storage unit 18 with multiple users.

Details of the respective units will hereinafter be described. Note that the light applying unit 11, the light detection unit 12, the excitation light detection unit 13, the flow paths P (P11 to P13), the excitation light calibration unit 15, the abnormality detection unit 16, the control unit 17, the storage unit 18, the display unit 19, the user interface 110, the oscillation element 111, and the isolation unit 112 are similar to the corresponding components in the first embodiment and the second embodiment. Accordingly, explanation of these components will be omitted here.

### (1) Processing Unit 14

The processing unit 14 in each of the particle detection device 1 and the particle detection system 2 according to the third embodiment identifies the above-mentioned delay time during isolation by using a feature value identified in reference to two or more delay times calculated from two or more different particle speeds. Specifically, for example, the delay time during isolation can be identified by using a feature value identified in reference to a first delay time calculated in a condition where the particle speed is kept constant and a second delay time calculated in a condition where a difference is produced in the particle speed.

According to the conventional technology in PTL 1 described above, an arrival time at a droplet charging position can be calculated in principle if a laser spot interval, a distance inside the flow path, and a distance at the liquid column portion are known. However, considering that a droplet interval ranges from several tens 10 to 100 μm, measurement accuracy by the length of 10 μm is also required for measurement of the distances described above.

However, the measurement targets described above are excitation light for the optical detection unit, a mechanical part for the droplet forming orifice, and liquid sending fluid for the liquid column end portion. In this case, highly accurate distance measurement is extremely difficult to achieve due to respective forms originally different form each other. Accordingly, this method is difficult to adopt for an actual sorting system.

Moreover, an isolation device such as a cell sorter having a high-speed sorting processing ability has a high driving frequency of the oscillation element 111 which forms droplets, i.e., small droplet intervals. In proportion to the high driving frequency, accuracy required for an arrival time at a droplet charging position also increases. Accordingly, extremely high measurement accuracy is required for the distance measurement described above, and hence, a new method for achieving this measurement accuracy is demanded.

Further, in a case of particle isolation by the Jet in Air detection system (see FIG. 8), a speed distribution inside the liquid column is constant at any position of each particle, and hence, identification of a delay time is not greatly affected by an increase in a sample core diameter. On the other hand, in a case of particle isolation by the Cuvette detection system, a Hagen-Poiseuille speed distribution is exhibited in a micro flow path inside the Cuvette (see FIG. 9). In this case, the particle speed varies in association with an increase in the sample core diameter, and hence, a delay time suited for each individual speed needs to be accumulated.

According to the present invention, therefore, calculation of the delay time is achieved by setting the following two measurement conditions for each of the Cuvette portion passing distance: x2 and the liquid column portion passing distance: x3.

(a) The particle speed in a case of a small sample core diameter in a sample liquid sending condition becomes Vmax, and an average flow speed becomes ½ Vmax by Navier-Stokes equations.

(b) If each of the Cuvette passing distance: x2 and the liquid column portion passing distance: x3 is appropriate, a breakoff point BOP arrival time calculated by the equation (6) described above becomes appropriate for both a particle having passed through a central portion and a particle having passed through an outer circumferential portion.

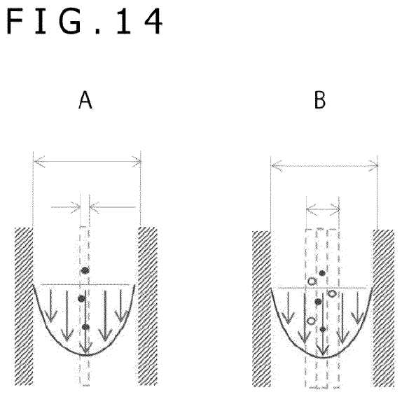

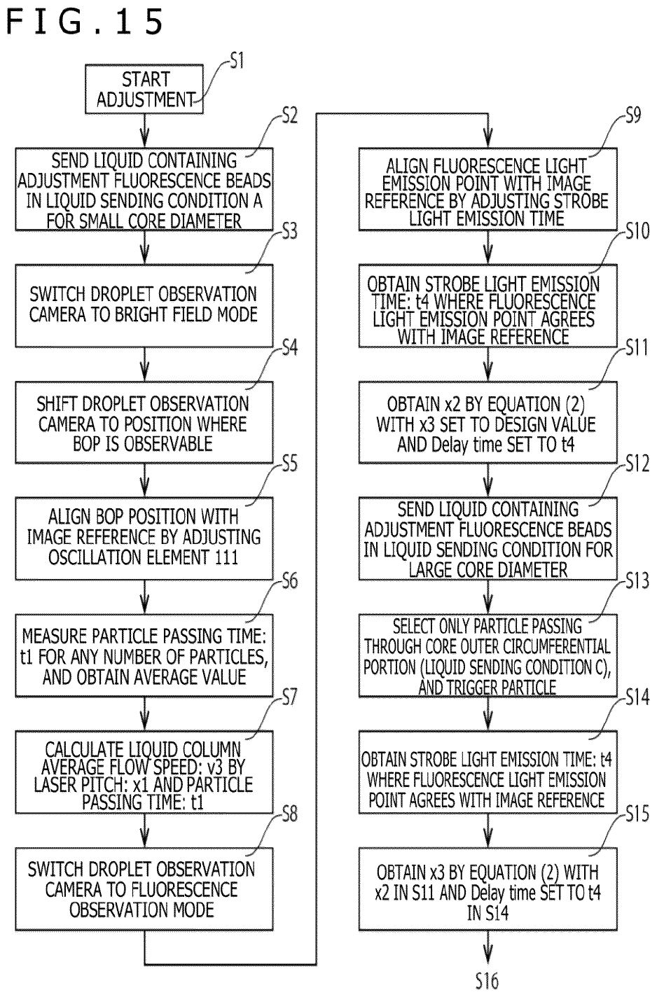

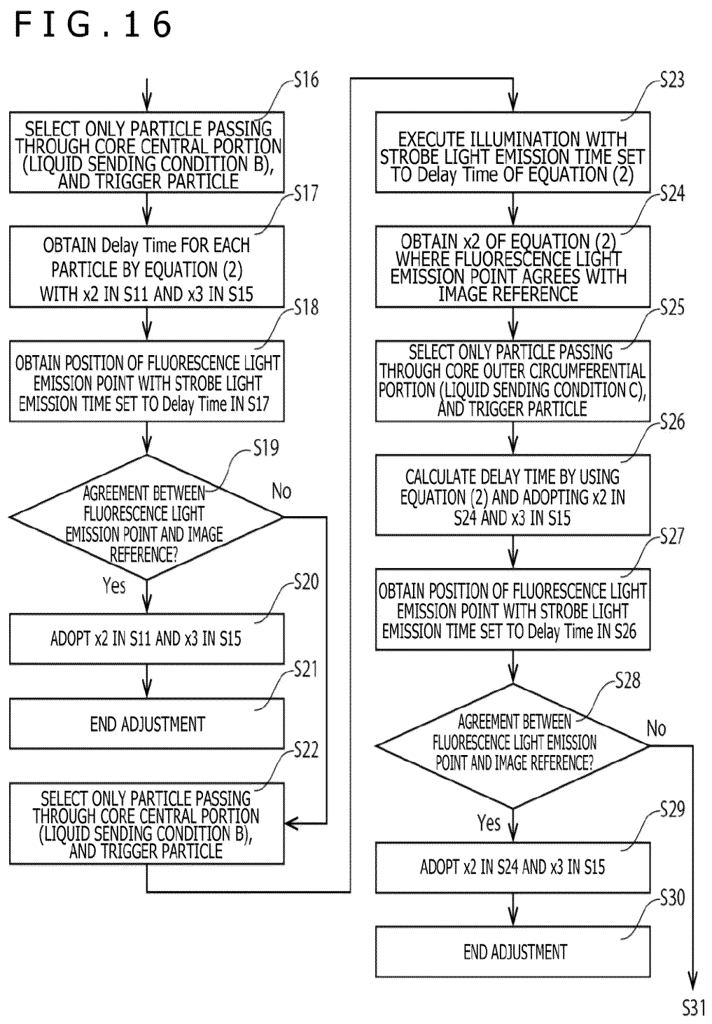

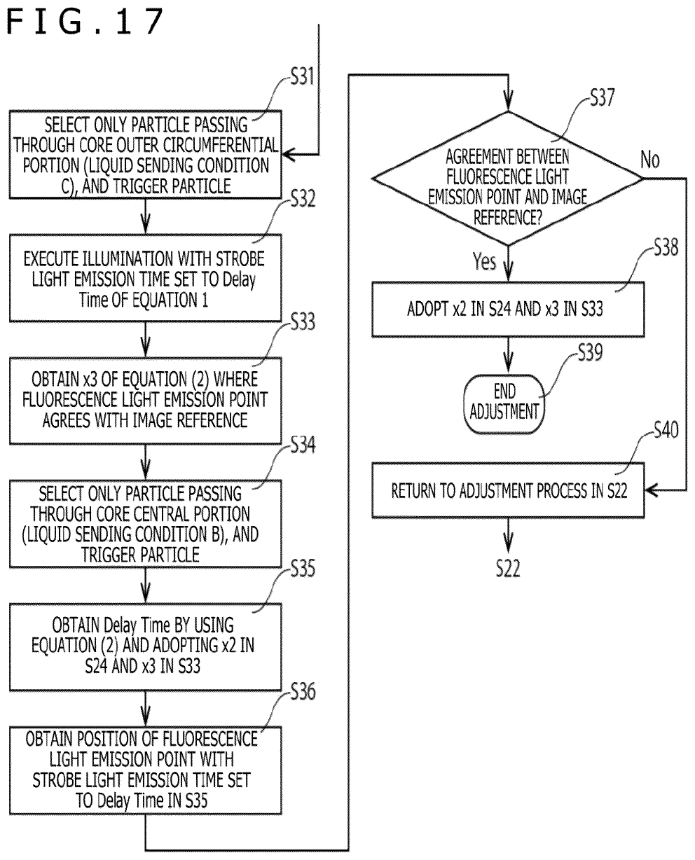

FIG. 14 depicts an example of a liquid sending condition used for delay time identification by the particle detection device 1 and the particle detection system 2 according to the third embodiment. First, a state of a small sample core is produced by setting a small quantity for sample sending liquid, and a particle speed at that time is defined as a central flow speed (maximum flow speed) and recorded (liquid sending condition A, see FIG. 14A). Next, the sample flow quantity is increased to create a state of a large sample core, i.e., a state where a difference is produced in the particle speed (liquid sending condition B, see FIG. 14B). With use of these liquid sending conditions and delay time adjustment algorithms S1 to S40 depicted in FIGS. 15 to 17, highly accurate delay time identification is achievable for any position each particle circulates through in the flow path of the Cuvette portion, i.e., even in a case where the liquid sending state varies.

The delay time adjustment algorithms will specifically be described below. First, liquid containing adjustment fluorescence beads is sent in the liquid sending condition A corresponding to the small core diameter (see FIG. 14A) (S2). The droplet observation camera C is switched to the bright field mode (S3), and shifted to a position where the breakoff point BOP is observable (S4). The position of the breakoff point BOP is aligned with an image reference by adjustment of the oscillation element 111 (S5). A passing time: t1 is measured for any number of particles (e.g., 1000 pieces), and an average value is obtained (S6). A liquid column average flow speed: V3 is calculated by a laser pitch: x1 and the particle passing time: t1 (S7). The droplet observation camera C is switched to the fluorescence observation mode (S8). A fluorescence light emission point is aligned with the image reference by adjustment of strobe light emission time (S9). A strobe light emission time: t4 at which the fluorescence light emission point agrees with the image reference is obtained (S10). A liquid column passing distance: x3 is set to a design value, the delay time is set to t4, and x2 is obtained with use of the equation (2) described above (S11).

Next, liquid containing the adjustment fluorescence beads is sent in the liquid sending condition B corresponding to the large core diameter (S12). Only particles passing through an outer circumferential portion of the core are selected (see white circles in FIG. 14B), and only particles flowing at a low speed are triggered, for example (S13). A strobe light emission time: t4 at which the fluorescence light emission point agrees with the image reference is obtained (S14). In reference to x2 obtained in S11 and the delay time set to t4 obtained in S14, x3 is calculated with use of the equation (2) described above (S15).

Subsequently, only particles passing through a central portion of the core are selected (liquid sending condition B, see black circles in FIG. 14B), and only particles flowing at a high speed are triggered, for example (S16). With use of x2 obtained in S11 and x3 obtained in S15, a delay time of each particle is calculated by the equation (2) described above (S17). The strobe light emission time is set to the delay time obtained in S17, and a position of the fluorescence light emission point is obtained (S18). In a case where the fluorescence light emission point agrees with the image reference, x2 obtained in S11 and x3 obtained in S15 are adopted (S20), and delay time identification ends (S21).

In a case where the fluorescence light emission point does not agree with the image reference, only particles passing through the central portion of the core are selected again (liquid sending condition B, see black circles in FIG. 14B), and only particles flowing at a high speed are triggered, for example (S22). The strobe light emission time is set to the delay time obtained using the equation (2) described above, and illumination is executed (S23). A value x2 of the equation (2) where the fluorescence light emission point agrees with the image reference is obtained (S24). Only particles passing through the outer circumferential portion of the core are selected (liquid sending condition B, see white circles in FIG. 14B), and only particles flowing at a low speed are triggered, for example (S25). A delay time is obtained by the equation (2) described above with use of x2 obtained in S24 and x3 obtained in S15 (S26). The strobe light emission time is set to the delay time obtained by the equation (2) described above, and a position of the fluorescence light emission point is obtained (S27). In a case where the fluorescence light emission point agrees with the image reference, x2 obtained in S24 and x3 obtained in S15 are adopted (S29), and delay time identification ends (S30).

In a case where the fluorescence light emission point does not agree with the image reference, only particles passing through the outer circumferential portion of the core are selected again (liquid sending condition B, see white circles in FIG. 14B), and only particles flowing at a low speed are triggered, for example (S31). The strobe light emission time is set to the delay time obtained by the equation (2) described above, and illumination is executed (S32). A value x3 based on the equation (2) where the fluorescence light emission point agrees with the image reference is obtained (S33). Only particles passing through the central portion of the core are selected (liquid sending condition B, see black circles in FIG. 14B), and triggered (S34). A delay time is obtained by the equation (2) described above with use of x2 obtained in S24 and x3 obtained in S33 (S35). The strobe light emission time is set to the delay time obtained in S35, and a position of the fluorescence light emission point is obtained (S36). In a case where the fluorescence light emission point agrees with the image reference, x2 obtained in S24 and x3 obtained in S33 are adopted (S38), and delay time identification ends (S39).

In a case where the fluorescence light emission point disagrees with the image reference, the process returns to S22 to repeat calculations.

Each of the particle detection device 1 and the particle detection system 2 according to the third embodiment described above is capable of accurately calculating the foregoing unknown numerical values, which are the Cuvette passing distance and the liquid column portion distance required for delay time identification and designated as unknown values, by using different states of liquid sending adjustment and the adjustment algorithms. Accordingly, highly accurate delay time identification is achievable for any position each particle circulates in the flow path of the Cuvette portion, i.e., even in a case where the liquid sending state varies.

While parameters are calculated with division into two parts, i.e., the central portion (high particle speed) and the outer circumferential portion (low particle speed), in the sample core flow, according to the above principle, respective parameters may be calculated with division into three or more small parts.

Moreover, in the initial condition in S2, the maximum flow speed Umax may be obtained in the state of the liquid sending condition B corresponding to the large core diameter, instead of the liquid sending condition A.

Furthermore, while the conditions for different particle speeds are created by the liquid sending condition being changed in the principle described above, conditions for different particle speeds may be also created according to a particle size difference, for example. Accordingly, respective parameters can be calculated with use of two or more types of particles having different particle sizes.

### [Modification of Third Embodiment]

The processing unit 14 may also identify the delay time during isolation by using a feature value identified in reference to two or more delay times calculated from two or more different particle speeds in a condition where a particle speed difference is produced. Described hereinbelow will be a modification of the delay time adjustment algorithms in the Cuvette detection system according to the third embodiment.

The delay time t4 can be calculated by the equation (7) presented below by the Cuvette detection system (see FIG. 9).

$$\begin{matrix}[ Math . 7 ] & \\ \begin{matrix}Sort Delay Time \text{:} t 4 = t 2 + t 3 \\ = x 2 \div v 2 + t 3\end{matrix} & ( 7 )\end{matrix}$$

Cuvette passing time: t2
Cuvette passing distance: x2
Cuvette particle speed: v2
liquid column portion passing time: t3

Assuming here that a particle speed at the optical detection unit is equal to the Cuvette passing speed, i.e., v2=v1=x1÷t1, the delay time t4 is represented as an equation of a laser spot passing time t1 relative to the particle speed as presented in the following equation (8).

$$\begin{matrix}[ Math . 8 ] & \\ \begin{matrix}Sort Delay Time \text{:} t 4 = x 2 \div v 1 + t 3 \\ = x 2 \times t 1 \div x 1 + t 3\end{matrix} & ( 8 )\end{matrix}$$

laser spot passing time: t1
laser spot interval: x1
particle speed during laser spot passing: v1

For obtaining the Cuvette passing distance x2 and the liquid column portion passing time t3, which are unknown values, by using the equation (8), measurement is executed at two or more points of different particle speeds, such as a central portion and an outer circumferential portion of the core, in the liquid sending condition corresponding to the large core diameter (see FIG. 14B).

In a case where a particle passes through the core central portion (see black circles in FIG. 14B), a delay time t4_in can be represented by the following equation (9) assuming that a laser spot passing time when the particle passes through the core central portion is t1_in.

[Math. 9]

t4_in=x2×t1_in÷x1_in+t3 (9)
laser spot passing time at core central portion: t1_in
laser spot interval during measurement at core central portion: x1_in

On the other hand, in a case where a particle passes through the core outer circumferential portion (see white circles in FIG. 14B), a delay time t4_out can be represented by the following equation (10) assuming that a laser spot passing time when the particle passes through the core outer circumferential portion is t1_out.

[Math. 10]

t4_out=x2×t1_out÷x1_out+t3 (10)
laser spot passing time at core outer circumferential portion: t1_out
laser spot interval during measurement at core outer circumferential portion: x1_out

Assuming that the laser spot interval is uniform for both the core central portion and the core outer circumferential portion during delay time adjustment, x1_in=x1_out holds on the basis of the equation (9) and the equation (10). Accordingly, the Cuvette passing distance x2 and the liquid column portion passing time t3 are represented by the following equation (11) and equation (12).

[Math. 11]

x2=(t4_out−t4_in)÷(t1_out−t1_in)×x1_in (11)

[Math. 12]

L3=(t1_out×t4_in−t1_in×t4_out)÷(t1_out−t1_in) (12)

The delay time t4 can hence be calculated by the following equation (13) for the laser spot passing time t1 and the laser spot interval x1 when a particle passes through any core position.

[Math. 13]

Sort Delay Time: t4=(t4_out−t4_in)÷(t1_out−t1_in)×t1×x1_in÷x1+(t1_out×t4_in−t1_in×t4_out)÷(t1_out−t1_in) (13)

Note that the liquid column portion passing time t3 can be calculated by the following equation (14) according to a flow path cross-sectional area a2 inside the Cuvette and a flow path cross-sectional area a3 at the liquid column portion if the liquid column portion passing distance x3 can be accurately obtained.

$$\begin{matrix}[ Math . 14 ] & \\ \begin{matrix}t 3 = x 3 \div v 3 \\ = x 3 \div \{ ( x 1 \times a 2 ) \div ( 2 \times t 1 \times a 3 ) \}\end{matrix} & ( 14 )\end{matrix}$$

flow path cross-sectional area inside Cuvette: a2
flow path cross-sectional area at liquid column portion: a3

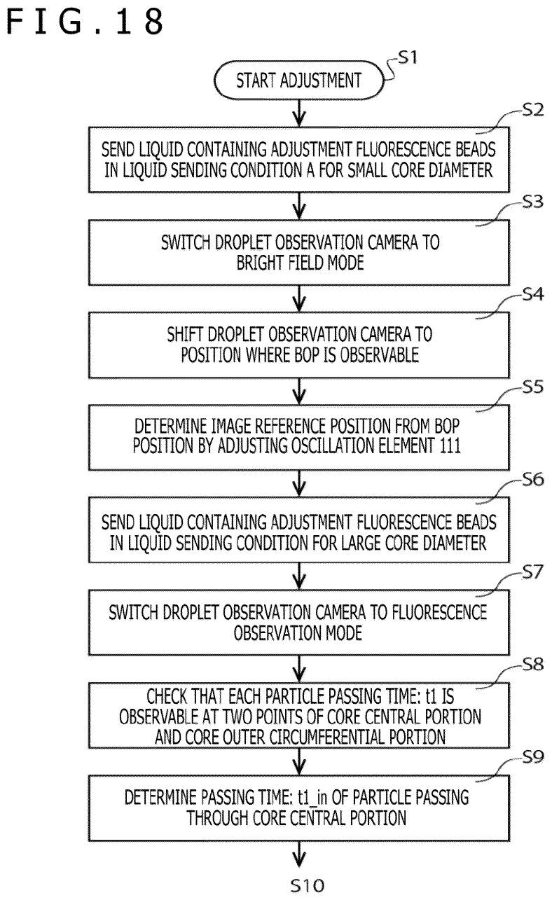

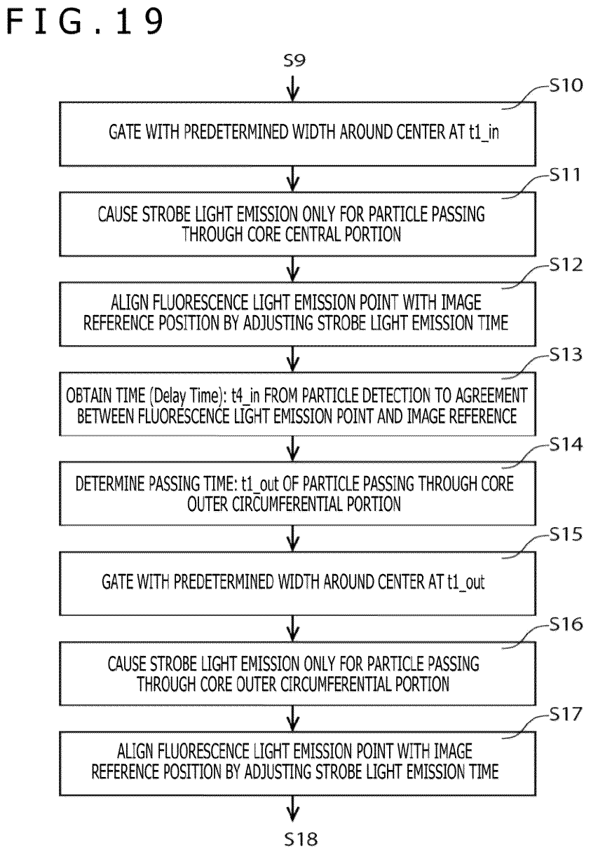

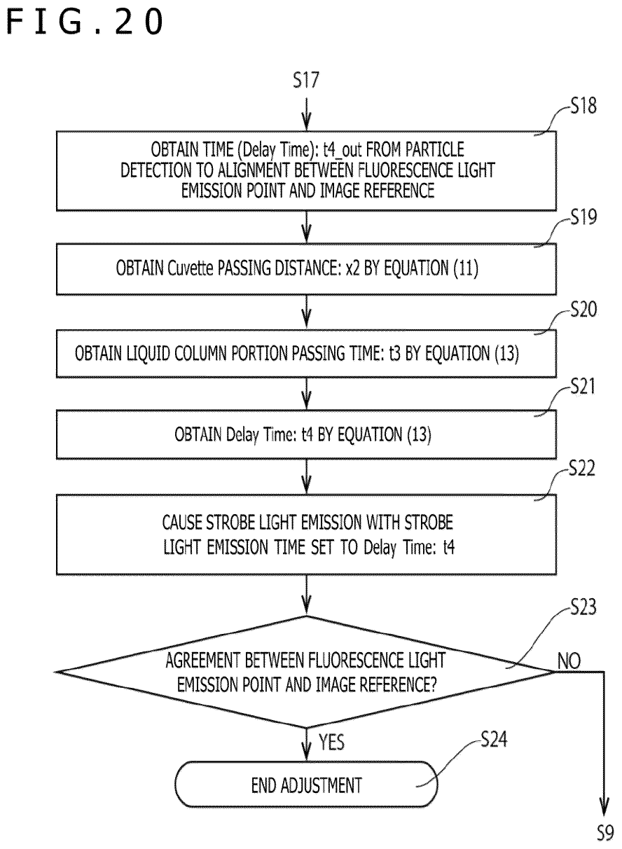

Specific delay time adjustment algorithms will hereinafter be described with reference to flowcharts in FIGS. 18 to 20.

First, liquid containing adjustment fluorescence beads is sent in the liquid sending condition A corresponding to the small core diameter (see FIG. 14A) (S2). The droplet observation camera C is switched to the bright field mode (S3), and shifted to a position where the breakoff point BOP is observable (S4). The position of the breakoff point BOP is aligned with an image reference by adjusting the oscillation element 111 (S5). The algorithms up to here are the same as the adjustment algorithms in FIG. 15 described above.

Subsequently, liquid containing adjustment fluorescence beads is sent in the liquid sending condition corresponding to the large core diameter (S6). The droplet observation camera C is switched to the fluorescence observation mode (S7). It is checked whether each particle passing time t1 is measurable at two or more points, such as a core central portion and a core outer circumferential portion (S8).

A laser spot passing time t1_in of a particle passing through the central portion of the core (see black circles in FIG. 14B) is determined (S9). Gating is established with a predetermined width around a center at the laser spot passing time t1_in (S10). Strobe light emission is caused only for each particle passing through the central portion of the core (S11). The fluorescence light emission point is aligned with an image reference position by adjustment of a strobe light emission time (S12). A time period from particle detection to alignment between the fluorescence light emission point and the image reference, i.e., a delay time t4_in, is obtained (S13).

A laser spot passing time t1_out of a particle passing through the outer circumferential portion of the core (see white circles in FIG. 14B) is determined (S14). Gating is established with a predetermined width around a center at the laser spot passing time t1_out (S15). Strobe light emission is caused only for each particle passing through the outer circumferential portion of the core (S16). The fluorescence light emission point is aligned with an image reference position by adjustment of a strobe light emission time (S17). A time period from particle detection to alignment between the fluorescence light emission point and the image reference, i.e., a delay time t4_out, is obtained (S18).

A Cuvette passing distance x2 is calculated using the equation (11) described above (S19). A liquid column portion passing time t3 is calculated using the equation (12) described above (S20). Thereafter, a delay time t4 is calculated using the equation (13) described above (S21).

The strobe emission time is set to the calculated delay time t4, and strobe light emission is caused (S22). It is checked whether or not the fluorescence light emission point agrees with the image reference (S23). If agreement is confirmed, adjustment ends (S24). If disagreement is confirmed, the process returns to S9.

While the conditions for different particle speeds are also created by changing the liquid sending condition in the modification of the third embodiment, respective parameters can be calculated with use of two or more types of particles having different particle sizes.

The processing unit 11 of each of the particle detection device 1 and the particle detection system 2 according to the third embodiment and the modification of the third embodiment described above is allowed to perform the processes carried out by the processing unit 11 of the second embodiment described above in conjunction with the above processes.

2. Particle detection method

### First Embodiment

A particle detection method according to a first embodiment is a method which performs at least a light applying step, a light detection step, an excitation light detection step, a droplet forming step, and an isolation step. Moreover, this particle detection method may also perform a processing step, an excitation light calibration step, an abnormality detection step, a control step, a storage step, a display step, and others as necessary.

### Second Embodiment

A particle detection method according to a second embodiment is a method which performs at least a light applying step, a light detection step, and an excitation light detection step. Moreover, this particle detection method may also perform a processing step, an excitation light calibration step, an abnormality detection step, a control step, a storage step, a display step, and others as necessary.

### Third Embodiment

A particle detection method according to a third embodiment is a method which performs at least a light applying step, a light detection step, a droplet forming step, an isolation step, and a processing step. Accordingly, an excitation light detection step is not an indispensable step for the particle detection method according to the third embodiment. However, needless to say, this particle detection method may also perform an excitation light detection step, an excitation light calibration step, an abnormality detection step, a control step, a storage step, a display step, and others as necessary.

Note that the respective steps are the same as those performed by the respective units of the particle detection device 1 and the particle detection system 2 according to the present technology described above. Accordingly, description of those steps is omitted here.

Note that the present technology may also have the following configurations.

(1)

A particle detection device including:
a light applying unit that applies excitation light to a particle contained in fluid;
a light detection unit that detects light emitted by application of the excitation light; and
an excitation light detection unit that has an imaging element that detects the excitation light applied to the particle.
   (2)

The particle detection device according to (1), in which
the light applying unit is configured to apply multiple rays of excitation light having different wavelengths from different positions in a flow direction of the fluid, and
the excitation light detection unit detects position information associated with the multiple rays of excitation light.
   (3)

The particle detection device according to (2), including:
a processing unit that identifies an interval of the multiple rays of excitation light in reference to the position information detected by the excitation light detection unit.
   (4)

The particle detection device according to (3), further including:
an oscillation element that applies oscillation to the fluid; and
an isolation unit that isolates a droplet containing the particle and formed by the oscillation, in which
the processing unit identifies a delay time from excitation light application to the particle to formation of the droplet containing the particle in reference to the identified interval of the multiple rays of excitation light.
   (5)

The particle detection device according to (4), in which
the processing unit determines a speed of the particle in reference to the interval of the multiple rays of excitation light and detection timing at which the particle is detected by the light detection unit, and
the processing unit identifies the delay time in reference to the speed of the particle.
   (6)

The particle detection device according to (4) or (5), in which the processing unit identifies the delay time during isolation by using a feature value identified in reference to two or more delay times calculated for two or more different particle speeds.

(7)

The particle detection device according to any one of (4) to (6), in which the processing unit identifies the delay time during isolation by using a feature value identified in reference to a first delay time calculated in a condition of a constant particle speed and a second delay time calculated in a condition where a particle speed difference is produced.

(8)

The particle detection device according to (7), in which the second delay time is a delay time calculated with use of light information from particles flowing at two or more different particle speeds in the condition where a particle speed difference is produced.

(9)

The particle detection device according to any one of (4) to (6), in which the processing unit identifies the delay time during isolation by using a feature value identified in reference to two or more delay times calculated for two or more different particle speeds in a condition where a particle speed difference is produced.

(10)

The particle detection device according to any one of (2) to (9), including:
an excitation light calibration unit that calibrates an interval of the rays of excitation light applied to the particle, in reference to the position information associated with the multiple rays of excitation light and acquired by the excitation light detection unit.
   (11)

The particle detection device according to any one of (1) to (10), including:
an abnormality detection unit that detects abnormality of the light applying unit in reference to excitation light intensity acquired by the excitation light detection unit.
   (12)

The particle detection device according to any one of (1) to (11), including:
a control unit that controls the light applying unit in reference to excitation light intensity acquired by the excitation light detection unit.
   (13)

A particle detection system including:
a particle detection device that includes
   a light applying unit that applies excitation light to a particle contained in fluid,
   a light detection unit that detects light emitted by application of the excitation light, and
   an excitation light detection unit that has an imaging element that detects the excitation light applied to the particle; and
an information processing device that has a processing unit that processes information detected with time by the excitation light detection unit.
   (14)

A particle detection method including:
a light applying step of applying excitation light to a particle contained in fluid;
a light detection step of detecting light emitted by application of the excitation light; and
an excitation light detection step of detecting, by using an imaging element, the excitation light applied to the particle.
   (15)

A particle detection device including:
a light applying unit that applies excitation light to a particle contained in fluid;
a light detection unit that detects light emitted by application of the excitation light;
an oscillation element that applies oscillation to the fluid;
an isolation unit that isolates a droplet containing the particle and formed by the oscillation; and
a processing unit that identifies the delay time during isolation by using a feature value identified in reference to two or more delay times calculated for two or more different particle speeds.
   (16)

A particle detection device including:
a processing unit that is the processing unit that identifies the delay time during isolation by using a feature value identified in reference to a first delay time calculated in a condition of a constant particle speed and a second delay time calculated in a condition where a particle speed difference is produced.
   (17)

The particle detection device according to (16), in which the second delay time is a delay time calculated with use of light information from particles flowing at two or more different particle speeds in the condition where a particle speed difference is produced.

(18)

The particle detection device according to (15), in which the processing unit identifies the delay time during isolation by using a feature value identified in reference to two or more delay times calculated for two or more different particle speeds in a condition where a particle speed difference is produced.

(19)

The particle detection device according to any one of (15) to (18), further including:
an excitation light detection unit that has an imaging element that detects the excitation light applied to the particle.
   (20)

The particle detection device according to (19), in which
the light applying unit is configured to apply multiple rays of excitation light having different wavelengths from different positions in a flow direction of the fluid, and
the excitation light detection unit detects position information associated with the multiple rays of excitation light.
   (21)

The particle detection device according to (20), including:
a processing unit that identifies an interval of the multiple rays of excitation light in reference to the position information detected by the excitation light detection unit.
   (22)

The particle detection device according to (21), in which
the processing unit identifies a delay time from excitation light application to the particle to formation of the droplet containing the particle in reference to the identified interval of the multiple rays of excitation light.
   (23)

The particle detection device according to (21) or (22), in which
the processing unit determines a speed of the particle in reference to the interval of the multiple rays of excitation light and detection timing at which the particle is detected by the light detection unit, and
the processing unit identifies the delay time in reference to the speed of the particle.
   (24)

The particle detection device according to any one of (20) to (23), including:
an excitation light calibration unit that calibrates an interval of the rays of excitation light applied to the particle, in reference to the position information associated with the multiple rays of excitation light and acquired by the excitation light detection unit.
   (25)

The particle detection device according to any one of (19) to (24), including:
an abnormality detection unit that detects abnormality of the light applying unit in reference to excitation light intensity acquired by the excitation light detection unit.
   (26)

The particle detection device according to any one of (19) to (25), including:
a control unit that controls the light applying unit in reference to excitation light intensity acquired by the excitation light detection unit.
   (27)

A particle detection system including:
a particle detection device that includes
   a light applying unit that applies excitation light to a particle contained in fluid,
   a light detection unit that detects light emitted by application of the excitation light,
   an oscillation element that applies oscillation to the fluid, and
   an isolation unit that isolates a droplet containing the particle and formed by the oscillation; and
an information processing device that has a processing unit that identifies the delay time during isolation by using a feature value identified in reference to two or more delay times calculated for two or more different particle speeds.
   (28)

A particle detection method including:
a light applying step of applying excitation light to a particle contained in fluid;
a light detection step of detecting light emitted by application of the excitation light;
a droplet forming step of oscillating the fluid to form a droplet;
an isolation step of isolating a droplet containing the particle and formed by the droplet forming step; and
a processing step of identifying the delay time during isolation by using a feature value identified in reference to two or more delay times calculated for two or more different particle speeds.

### REFERENCE SIGNS LIST

1: Particle detection device
2: Particle detection system
P, P11, P12, P13: Flow path
P14: Orifice
11: Light applying unit
12: Light detection unit
13: Excitation light detection unit
14: Processing unit
15: Excitation light calibration unit
16: Abnormality detection unit
17: Control unit
18: Storage unit
19: Display unit
110: User interface
111: Oscillation element
112: Isolation unit
112a: Charging unit
112b: Counter electrode
10: Information processing device
JF: Jet flow
L: Liquid column portion
BOP: Breakoff point

1. A particle detection device comprising:
a light applying unit that applies excitation light to a particle contained in fluid;
a light detection unit that detects light emitted by application of the excitation light; and
an excitation light detection unit that has an imaging element that detects the excitation light applied to the particle.

2. The particle detection device according to claim 1, wherein
the light applying unit is configured to apply multiple rays of excitation light having different wavelengths from different positions in a flow direction of the fluid, and
the excitation light detection unit detects position information associated with the multiple rays of excitation light.

3. The particle detection device according to claim 2, comprising:
a processing unit that identifies an interval of the multiple rays of excitation light in reference to the position information detected by the excitation light detection unit.

4. The particle detection device according to claim 3, further comprising:
an oscillation element that applies oscillation to the fluid; and
an isolation unit that isolates a droplet containing the particle and formed by the oscillation, wherein
the processing unit identifies a delay time from excitation light application to the particle to formation of the droplet containing the particle in reference to the identified interval of the multiple rays of excitation light.

5. The particle detection device according to claim 4, wherein
the processing unit determines a speed of the particle in reference to the interval of the multiple rays of excitation light and detection timing at which the particle is detected by the light detection unit, and
the processing unit identifies the delay time in reference to the speed of the particle.

6. The particle detection device according to claim 4, wherein the processing unit identifies the delay time during isolation by using a feature value identified in reference to two or more delay times calculated for two or more different particle speeds.

7. The particle detection device according to claim 6, wherein the processing unit identifies the delay time during isolation by using a feature value identified in reference to a first delay time calculated in a condition of a constant particle speed and a second delay time calculated in a condition where a particle speed difference is produced.

8. The particle detection device according to claim 7, wherein the second delay time is a delay time calculated with use of light information from particles flowing at two or more different particle speeds in the condition where a particle speed difference is produced.

9. The particle detection device according to claim 6, wherein the processing unit identifies the delay time during isolation by using a feature value identified in reference to two or more delay times calculated for two or more different particle speeds in a condition where a particle speed difference is produced.

10. The particle detection device according to claim 2, comprising:
an excitation light calibration unit that calibrates an interval of the rays of excitation light applied to the particle, in reference to the position information associated with the multiple rays of excitation light and acquired by the excitation light detection unit.

11. The particle detection device according to claim 1, comprising:
an abnormality detection unit that detects abnormality of the light applying unit in reference to excitation light intensity acquired by the excitation light detection unit.

12. The particle detection device according to claim 1, comprising:
a control unit that controls the light applying unit in reference to excitation light intensity acquired by the excitation light detection unit.

13. A particle detection system comprising:
a particle detection device that includes
a light applying unit that applies excitation light to a particle contained in fluid,
a light detection unit that detects light emitted by application of the excitation light, and
an excitation light detection unit that has an imaging element that detects the excitation light applied to the particle; and
an information processing device that has a processing unit that processes information detected with time by the excitation light detection unit.

14. A particle detection method comprising:
a light applying step of applying excitation light to a particle contained in fluid;
a light detection step of detecting light emitted by application of the excitation light; and
an excitation light detection step of detecting, by using an imaging element, the excitation light applied to the particle.
